(19) United States
(12) Patent Application Publication
(10) Pub. No.: US 2015/0379419 A1
(43) Pub. Date: Dec. 31, 2015

(54) GHOST-PATTERN ANALYZER

(71) Applicant: International Business Machines Corporation, Armonk, NY (US)

(72) Inventors: Francis X. Reddington, Sarasota, FL (US); Neil Sahota, Costa Mesa, CA (US)

(21) Appl. No.: 14/315,391

(22) Filed: Jun. 26, 2014

(51) Int. Cl. G06N 99/00; G06N 7/00; G06N 5/04

(52) U.S. Cl. CPC G06N 99/005; G06N 5/047; G06N 7/005

(57) ABSTRACT

A method and associated system for identifying and eliminating illusory “ghost” patterns that lead to inaccurate predictions of an outcome of a proposed solution, plan, or decision implemented within a particular scenario or context. A processor stores descriptions of patterns that are each be inferred from an expectation that a particular proposed solution will lead to a desired objective within the context of a particular scenario. The user enters a proposed solution, the processor attempts to select a pattern that aligns the solution with the objective, updates the entered solution with additional data needed to fully identify requirements of the reference pattern, determines how closely the updated solution satisfies those requirements, and revises or replaces the pattern if is identified as a ghost pattern incapable of ensuring alignment. The processor then identifies a likelihood of success of the proposed solution and recommends a course of action.

### TECHNICAL FIELD

The present invention relates to identifying a falsely perceived pattern in a decision-making process.

### BACKGROUND

Even a well-informed, experienced decision-maker can make an ineffective decision or one that produces unexpected consequences. Such a decision may occur because the decision-maker perceives false “ghost” patterns among factors upon which the decision depends.

### BRIEF SUMMARY

A first embodiment of the present invention provides a method for identifying and eliminating a false pattern among elements of a proposed course of action, the method comprising:

a processor of a computer system initializing a reference database with records that are each associated with a pattern of decision-making factors, wherein a first pattern of the plurality of patterns is associated with a first proposed course of action undertaken within a first scenario in order to attain a first objective, and wherein a second pattern of the plurality of patterns is associated with a second proposed course of action undertaken within the first scenario in order to attain the first objective;

the processor storing in a first record of a planning database information that describes the first proposed course of action;

the processor selecting the first pattern as a function of information stored in the first record;

the processor identifying information missing from the first record as a function of the first pattern;

the processor attempting to retrieve the missing information;

the processor updating the first record as a function of the retrieved information;

the processor determining that the updated first record is not aligned with the first pattern;

the processor choosing the second pattern in response to the determining;

the processor concluding that the updated first record is aligned with the second pattern; and

the processor confirming that the first objective is aligned with the second proposed course of action as a function of the determining that the updated first record is aligned with the second pattern.

A second embodiment of the present invention provides a computer program product, comprising a computer-readable hardware storage device having a computer-readable program code stored therein, said program code configured to be executed by a processor of a computer system to implement a method for identifying and eliminating a false pattern among elements of a proposed course of action, the method comprising:

the processor initializing a reference database with records that are each associated with a pattern of decision-making factors, wherein a first pattern of the plurality of patterns is associated with a first proposed course of action undertaken within a first scenario in order to attain a first objective, and wherein a second pattern of the plurality of patterns is associated with a second proposed course of action undertaken within the first scenario in order to attain the first objective;

the processor storing in a first record of a planning database information that describes the first proposed course of action;

the processor selecting the first pattern as a function of information stored in the first record;

the processor identifying information missing from the first record as a function of the first pattern;

the processor attempting to retrieve the missing information;

the processor updating the first record as a function of the retrieved information;

the processor determining that the updated first record is not aligned with the first pattern;

the processor choosing the second pattern in response to the determining;

the processor concluding that the updated first record is aligned with the second pattern; and

the processor confirming that the first objective is aligned with the second proposed course of action as a function of the determining that the updated first record is aligned with the second pattern.

A third embodiment of the present invention provides a computer system comprising a processor, a memory coupled to said processor, and a computer-readable hardware storage device coupled to said processor, said storage device containing program code configured to be run by said processor via the memory to implement a method for identifying and eliminating a false pattern among elements of a proposed course of action, the method comprising:

the processor initializing a reference database with records that are each associated with a pattern of decision-making factors, wherein a first pattern of the plurality of patterns is associated with a first proposed course of action undertaken within a first scenario in order to attain a first objective, and wherein a second pattern of the plurality of patterns is associated with a second proposed course of action undertaken within the first scenario in order to attain the first objective;

the processor storing in a first record of a planning database information that describes the first proposed course of action;

the processor selecting the first pattern as a function of information stored in the first record;

the processor identifying information missing from the first record as a function of the first pattern;

the processor attempting to retrieve the missing information;

the processor updating the first record as a function of the retrieved information;

the processor determining that the updated first record is not aligned with the first pattern;

the processor choosing the second pattern in response to the determining;

the processor concluding that the updated first record is aligned with the second pattern; and

the processor confirming that the first objective is aligned with the second proposed course of action as a function of the determining that the updated first record is aligned with the second pattern.

### BRIEF DESCRIPTION OF THE DRAWINGS

FIG. 1 shows a structure of a computer system and computer program code that may be used to implement a method for ghost-pattern analysis in accordance with embodiments of the present invention.

FIG. 2 is a structure diagram that shows relationships among component modules of a ghost-pattern analyzer in accordance with embodiments of the present invention.

FIG. 3 is a flow chart that illustrates steps of a method for ghost-pattern analysis in accordance with embodiments of the present invention.

FIG. 4 illustrates a high-level organization of a minimum embodiment of a ghost-pattern data model, in accordance with embodiments of the present invention.

FIG. 5A illustrates details of items of FIG. 4 that show the Questions & Answer substructure, the Objectives & Domain substructure, and the Context & Relevance substructure of a minimum ghost-pattern data structure in accordance with embodiments of the present invention.

FIG. 5B illustrates details of items of FIG. 4 that show the Ghost-patterns & Influencers substructure and the Analysis substructure of a minimum ghost-pattern data structure in accordance with embodiments of the present invention.

FIG. 5C illustrates details of items of FIG. 4 that show the Strategies & Alignment substructure and the Ideas, Products, Processes, & Opportunities substructure of a minimum ghost-pattern data structure in accordance with embodiments of the present invention.

FIG. 5D shows details of FIG. 4's Cost/Benefit substructure of a minimum ghost-pattern data structure in accordance with embodiments of the present invention.

FIG. 5E illustrates details of items of FIG. 4's Context & Pattern Relevance module in accordance with embodiments of the present invention.

### DETAILED DESCRIPTION

Embodiments of the present invention provide a means of identifying and mitigating ill effects of mistakenly perceived illusory “ghost” patterns. Here, a pattern comprises a selection of and an organization of elements of a plan or solution that may lead to a particular conclusion. A ghost pattern is an illusory pattern that, despite superficial appearances, does not truly organize elements of a plan or solution in a way that leads to the particular conclusion.

A ghost pattern may thus imply an existence of a relationship among or organization of entities when, in fact, no such pattern, relationship, or organization actually exists among the entities under consideration. In such cases, identification of the pattern as a ghost pattern may reveal that a pattern, relationship, or organization of the entities has been misapplied to the entities under consideration; or that the pattern is for some other reason not useful for or appropriate to the current scenario, application, project, or decision-making process.

In embodiments, described herein, such entities or other data may comprise, but is not limited to, a combination of an objective, an idea, a strategy, a process, a product, an opportunity, a research result, a proposal, or an other component of a business plan, strategy, road map, or product of any other decision-making effort.

Embodiments of the present invention address this issue by representing elements of a decision-making process as a relational model and by using characteristics of this model to identify, characterize, and quantify patterns among elements of the model. In this way, it may be possible to determine a likelihood that a detected pattern is true, accurate, and appropriate to the decision-making process.

In embodiments described herein, a user may respond to a scenario by proposing a solution in order to produce a desired outcome. Here, a scenario is a set of circumstances, constraints, objectives, plans, events, environmental factors, other extrinsic conditions, or other contextual information that together describe a real-world situation to which the user wishes to respond.

Embodiments of the present invention may in part determine whether a user's proposed solution or course of action is based on a perceived pattern likely to be an illusory ghost pattern by predicting a most likely outcome of the proposed solution and comparing that likely outcome to the user's expected outcome.

In a simple example, a scenario might comprise a user's need to enter a new market effectively, and the user's proposed solution might comprise effectively addressing the new market by elaborating an existing marketing campaign that has in the past been effective in other markets. Here, embodiments of the present invention might identify a perceived pattern upon which a user's proposed solution is based, and then determine a likelihood that this pattern is a ghost pattern. This determination might be performed by identifying that the marketing campaign is likely to yield unexpected results that differ from the results expected by the user—thus suggesting that the pattern is a ghost pattern.

In another example, a cell-phone manufacturer user may propose a response to a scenario that comprises a declining market for phones that lack high-output speakers and a rising wholesale cost of neodymium magnets needed to produce such speakers. The user may propose a response that comprises adding high-output speakers to its current product line, but maintaining current its pricing structure by eliminating other less-desirable features. The desired outcome would be to offer a cell phone with high-output speakers at current pricing levels.

Embodiments of the present invention may further define, in descending order of breadth, an objective (a generalized purpose), a goal (a specific way to achieve an objective), a strategy (a practical decision made in order to attain a goal), and an initiative (a step-by-step plan to implement a strategy).

In one example, a business may have a general objective to increase its stock price. This objective may give rise to a set of goals that each have a likelihood of increasing the business's stock price. Such goals might comprise increasing productivity by 5% during the next two quarters, reducing manufacturing costs by $850,000 over the next five years, or increasing revenue by 10% over the next three fiscal years. One strategy for so increasing revenue might comprise entering a foreign market over the next fiscal year. The business might then undertake an initiative to enter the foreign market, wherein the initiative comprised the steps of: performing market research, identifying a compatible foreign manufacturing resource, and entering into a strategic partnership with a foreign distributor.

This example might be especially appropriate as a response to a scenario in which global financial conditions are exerting downward pressure on stock prices of companies that do not have a global presence. Here, a proposed solution that comprises entering the foreign market might be considered a credible path to an outcome of increased revenue or of increased stock price.

In other embodiments, objectives, goals, strategies, and initiatives might be defined differently or might be combined. Objectives and goals might be considered to be synonymous, for example, leading to a definition of a strategy as a decision made in order to attain an objective.

As will be described below, embodiments of the present invention may identify characteristics of each of these entities, or relationships among instances of these entities, as data stored in records or fields of a database sub-schema or other data structure.

Embodiments of the present invention relate scenarios to proposed solutions by identifying one or more patterns implicit to a scenario/solution combination. In the ongoing example, the proposed solution of entering the foreign market under constraints imposed by the decreasing stock-price scenario might allow an embodiment to infer a pattern that relates entering the foreign market with increased revenues, or that relates increased revenues to increased stock prices. As will be discussed below, if such a pattern does not accurately represent true relationships among characteristics of the scenario and of the proposed solution, then the embodiment might deem such a pattern to be an illusory “ghost pattern,” and entering the foreign market might produce unintended results.

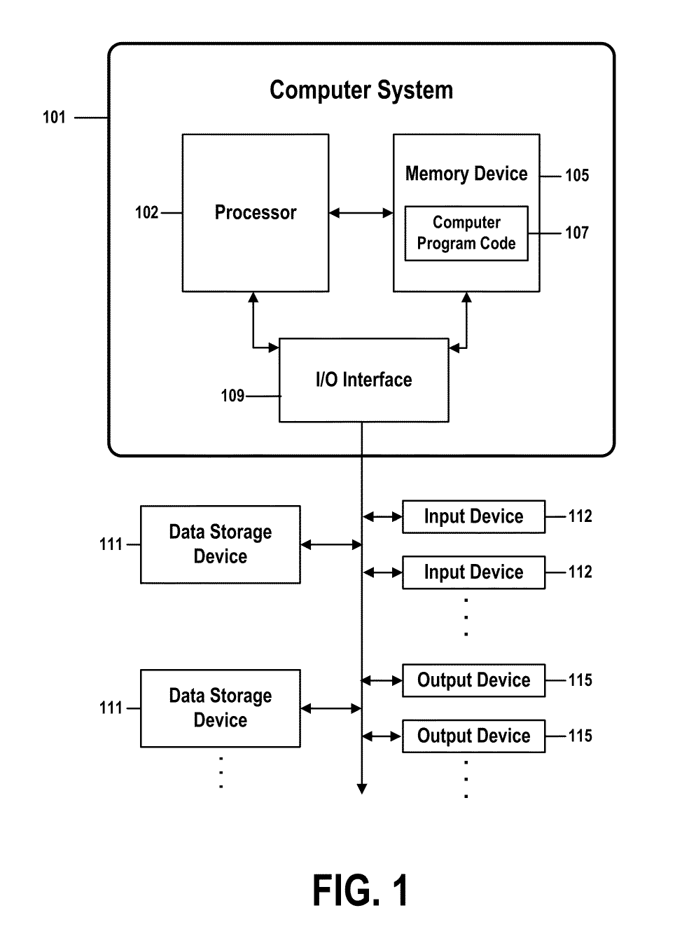

FIG. 1 shows a structure of a computer system and computer program code that may be used to implement a method for analyzing Ghost-Patterns in accordance with embodiments of the present invention. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for analyzing Ghost-Patterns in accordance with embodiments of the present invention, and may implement other embodiments described in this specification, including the methods illustrated in FIGS. 1-5E. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for analyzing Ghost-Patterns.

Any of the components of the present invention could be created, integrated, hosted, maintained, deployed, managed, serviced, supported, etc. by a service provider who offers to facilitate a method for analyzing Ghost-Patterns. Thus the present invention discloses a process for deploying or integrating computing infrastructure, comprising integrating computer-readable code into the computer system 101, wherein the code in combination with the computer system 101 is capable of performing a method for analyzing Ghost-Patterns.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for cross-retail marketing based on analytics of multichannel clickstream data may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for cross-retail marketing based on analytics of multichannel clickstream data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

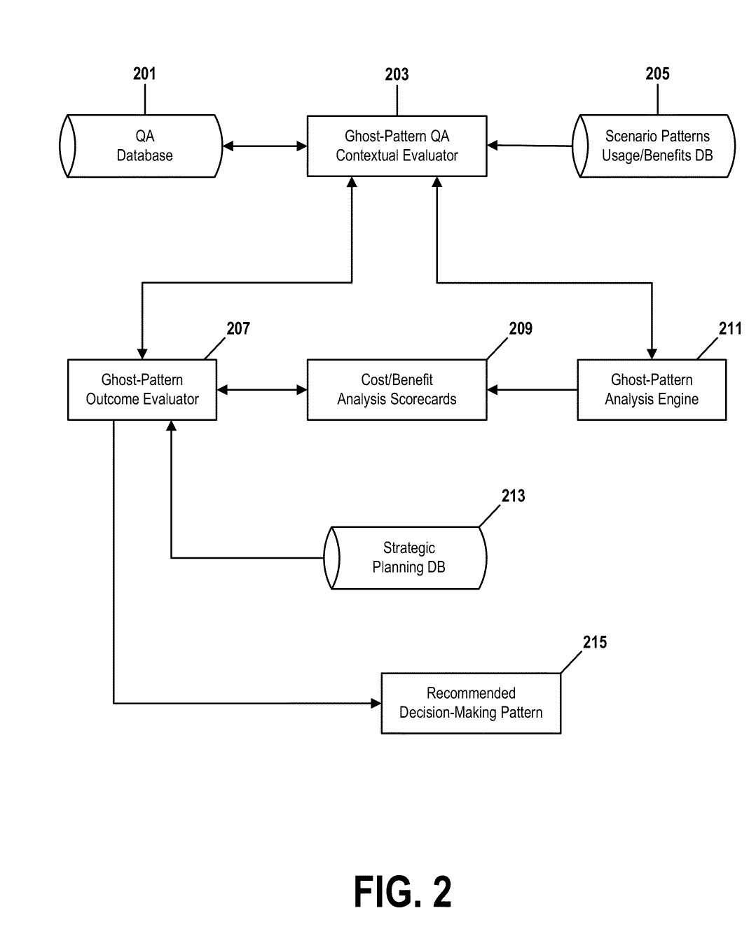

FIG. 2 is a structure diagram that shows relationships among component modules of a ghost-pattern analyzer in accordance with embodiments of the present invention. FIG. 2 comprises items 201-215.

Question/Answer Database 201 stores data and logic that allow a Ghost-Pattern QA Contextual Evaluator 203 to select a context-sensitive sequence of queries in order to contextualize previously collected decision-making information. In some embodiments, the Question/Answer Database 201 may store data and logic that generate negative questions capable of invalidating a pattern inferred in the previously collected decision-making information.

Ghost-Pattern QA Contextual Evaluator 203 solicits information from extrinsic sources, such as a user or an external database or other information repository, in order to: contextualize previously collected information that may be forwarded to other components; to populate instances of a Ghost-Pattern framework data model; or to help quantify subjected elements of the previously collected decision-making information. In some embodiments, this soliciting may be performed interactively or noninteractively by asking questions selected from the Question/Answer Database 201.

Scenario Patterns Usage/Benefits Database 205 stores historical or forecasted usage patterns that may be manually entered or automatically derived as a function of details of one or more scenarios. A scenario in this context comprises a set of circumstances, constraints, objectives, plans, events, environmental factors, other extrinsic conditions, or other contextual information that describe a real-world situation. Embodiments of the present invention may in part determine whether a user's perceived pattern is more or less likely to be a ghost pattern by determining costs and benefits that arise when a proposed course of action based on a ghost pattern is chosen as a way to respond to a particular scenario.

In one example, a scenario might comprise a user selecting a marketing-campaign slogan that must be effective in multiple markets. In this example, embodiments of the present invention might determine if a perceived pattern is more or less likely to be a ghost pattern by identifying costs and benefits that would arise if the pattern were used to organize components of such a scenario.

In some embodiments, the Contextual Evaluator 203 may consider a sequence of events identified by such a pattern in order to determine how best to identify, collect, characterize, or contextualize decision-making information.

Continuing the previous example, a pattern stored in the Scenario Patterns Usage/Benefits Database 205 might identify a sequence of events associated with the scenario in which the marketing team executes processes to create a marketing campaign message for multiple target markets. This sequence of events might comprise steps of:
i) validating each proposed marketing-campaign message by analyzing a decision-making pattern associated with each associated target market;
ii) analyzing marketing triggers for each target market, and
iii) assessing whether each marketing-campaign message is based on assumptions comprised by a ghost pattern that might lead to an unsuccessful outcome.

Ghost-Pattern Outcome Evaluator 207 consolidates and analyzes information received from the rest of the system in order to forecast possible outcomes likely to result from a particular identified decision-making pattern. Such an outcome might comprise, but is not limited to, a combination of a cost, a benefit, an advantage, or a disadvantage.

Cost/Benefit Analysis Scorecards 209 comprise scores assigned to costs and benefits associated with identified decision-making patterns.

Ghost-Pattern Analysis Engine 211 determines whether an applied decision-making pattern is appropriate for a particular scenario.

Strategic Planning Database 213 stores extrinsic information used by the Outcome Evaluator 207 to forecast a likely outcome of selecting a particular identified decision-making pattern. This stored extrinsic information may comprise, but is not limited to, descriptions of combinations or subsets of business goals, business/industry drivers, business cases, resource availability, current initiatives, organizational processes, domain knowledge, opportunity information, or alignment compatibilities.

Recommended Decision-Making Pattern 215 is an output produced by embodiments of the present invention that identifies a decision-making pattern least likely to be a false ghost pattern.

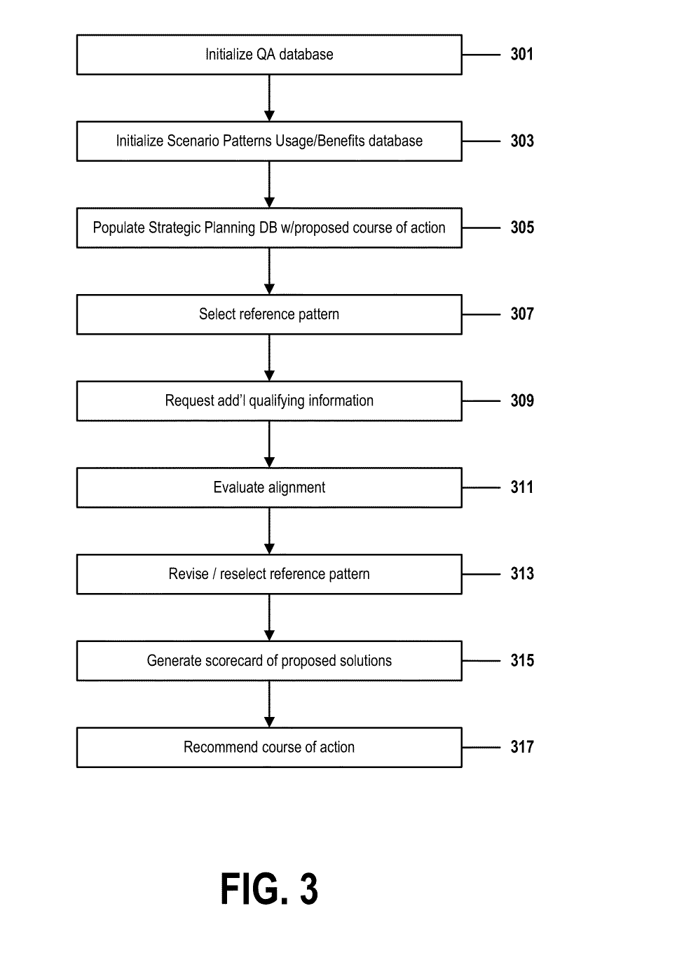

FIG. 3 is a flow chart that illustrates steps of a method for a ghost-pattern analyzer in accordance with embodiments of the present invention. FIG. 3 contains steps 301-317.

In step 301, one or more processors of a computer system begin populating reference databases with data and logic required by later steps of the method of FIG. 3. This populating comprises stocking QA Database 201 with sequences of questions needed to elicit information from a user. Some embodiments may further comprise a step of stocking QA Database 201 with possible answers to these questions or with logic that may determine a question to ask as a function of the user's answers to one or more other questions, of characteristics of the user's proposed solutions or scenarios, or of other factors related to the current implementation.

This stocking may be performed manually, automatically, or by means of both methods. In some cases, the stocking may be performed by a person who possesses expert knowledge of the user, the user's business, the market within which the user's business operates, or an other set of relevant criteria.

In step 303, the processors continue populating reference databases by adding records to the Scenario Patterns Usage/Benefits database 205. Each record of the Scenario Patterns Usage/Benefits database 205 describes characteristics of a pattern that might be inferred from a scenario.

In some embodiments, the Scenario Patterns Usage/Benefits database 205 may comprise a large number of records, each of which identifies characteristics of a pattern that might be broadly associated with scenario or with a class of scenario. In other embodiments, the Scenario Patterns Usage/Benefits database 205 may store a smaller number of records that are each associated with a more narrowly drawn scenario and pattern. The number of records and the breadth or narrowness of the scenarios and patterns stored in database 205 may be implementation-dependent and may be a function of a characteristic of the user, the user's business, the user's market, the intent of the embodiment, or of other relevant factors.

In some embodiments, the Scenario Patterns Usage/Benefits database 205 may be populated with logic and procedural steps that characterize a pattern or that otherwise identify business drivers associated with the pattern. If, for example, an existence of a pattern in a proposed solution, within the context of a particular scenario, may be determined only if twenty business/industry drivers associated with the pattern may be satisfied by adopting the proposed solution, then the Scenario Patterns Usage/Benefits database 205 may store twenty records associated with the pattern and scenario. Here, each of those twenty records would describe characteristics of one of those drivers.

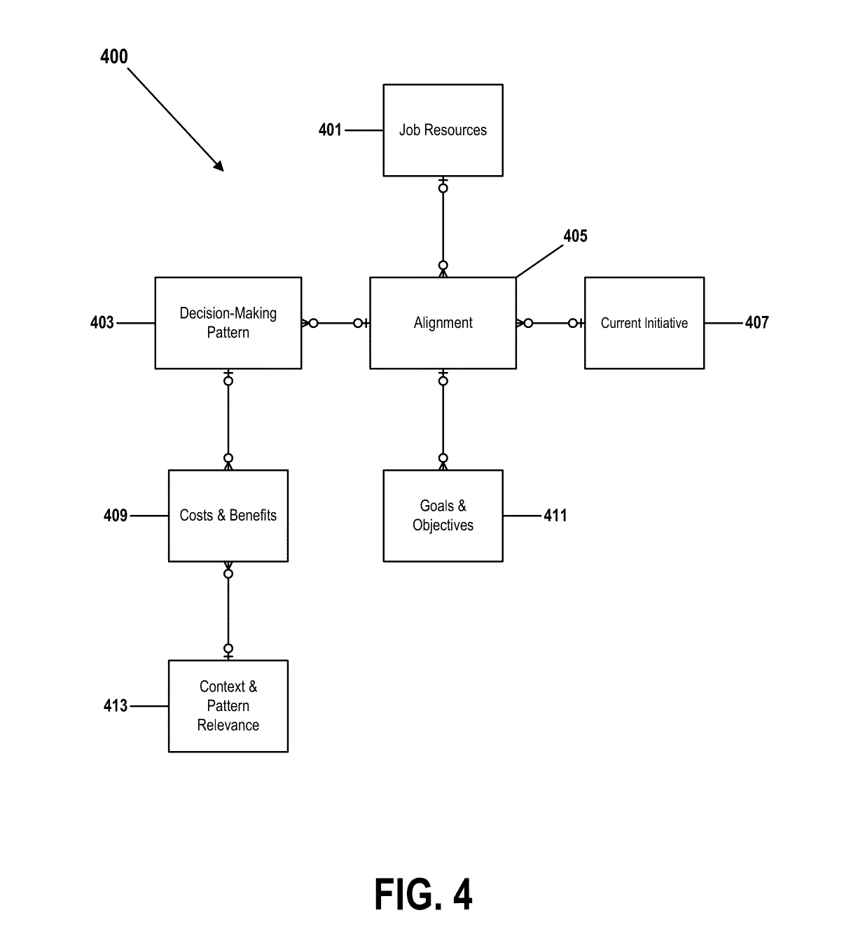

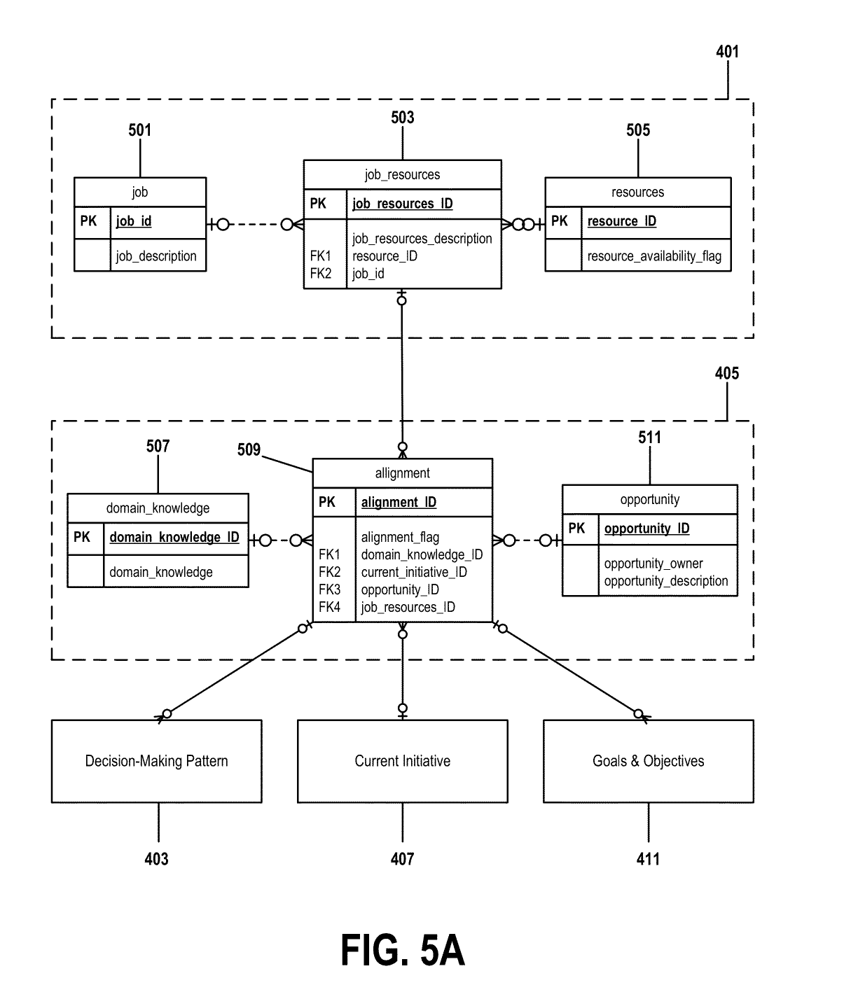

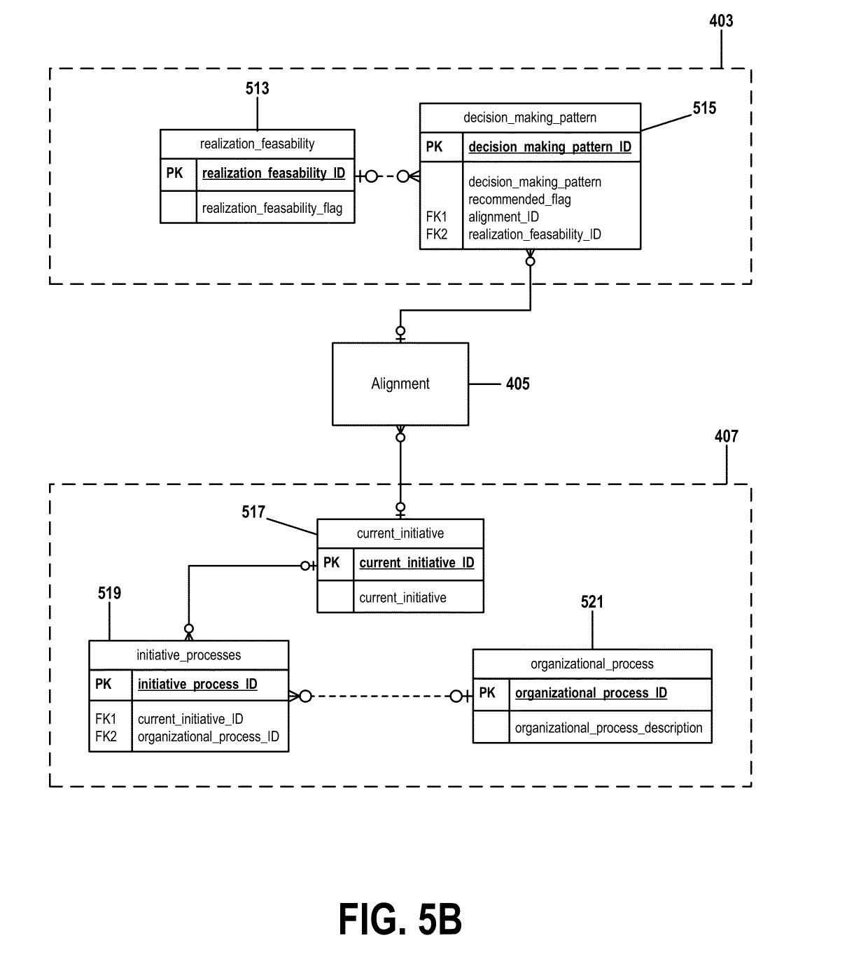

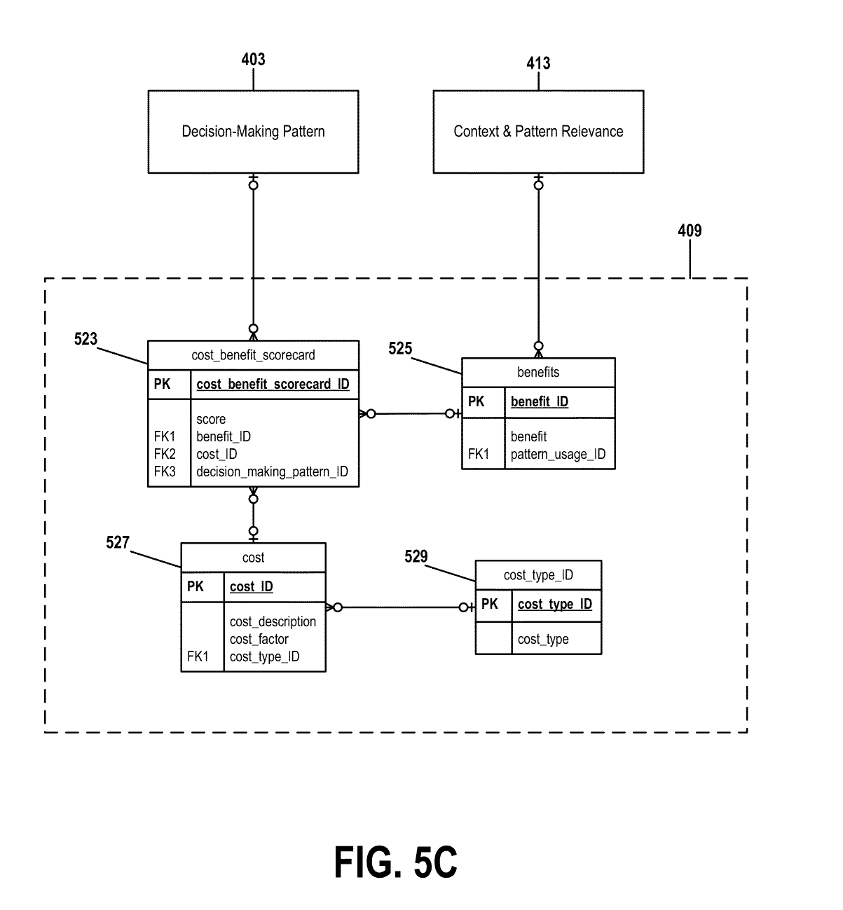

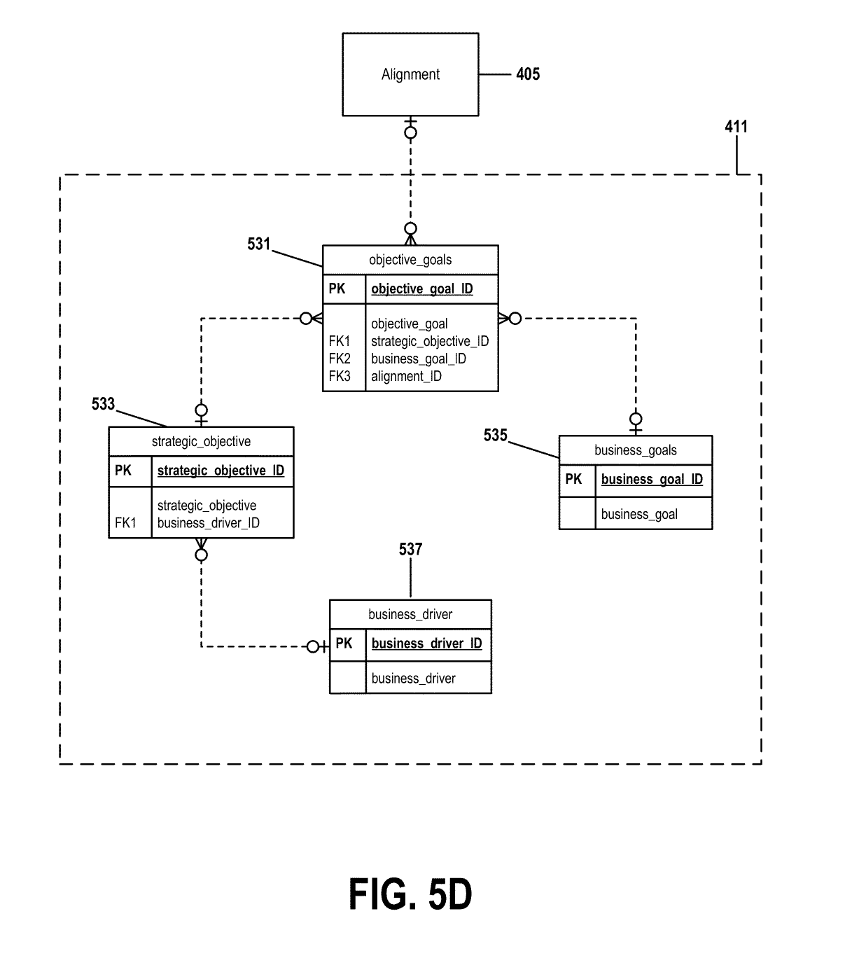

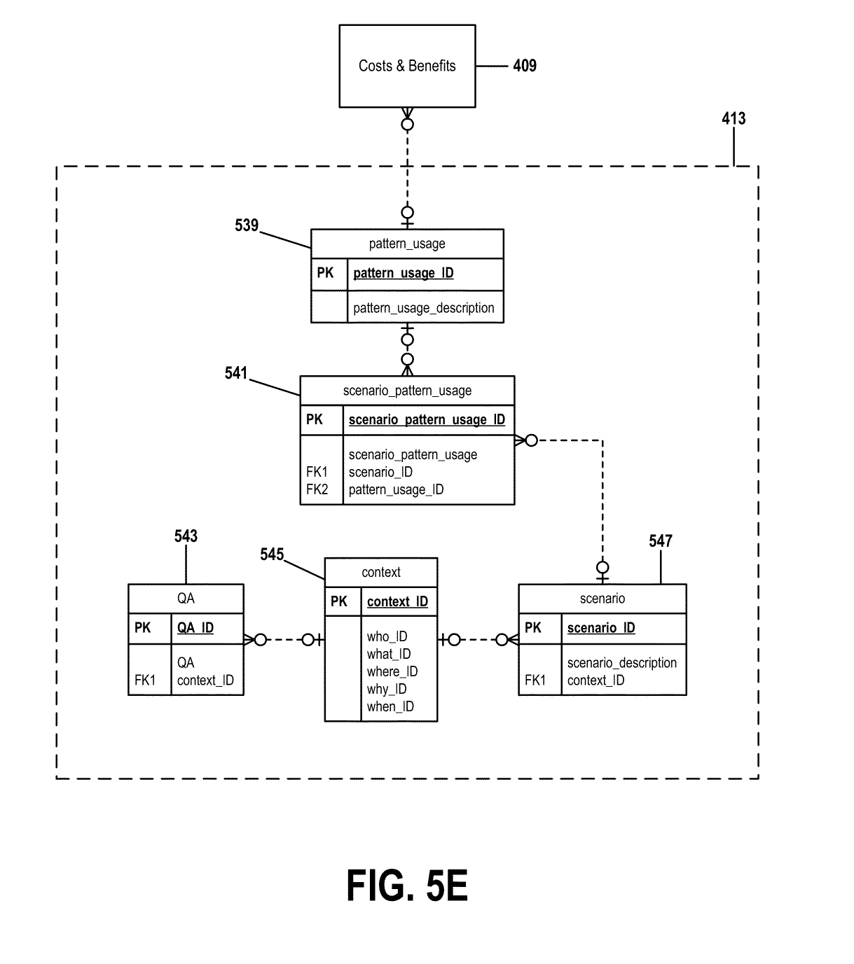

In some embodiments, the processors may, in step 301 or 303, further populate other tables and fields of one or more reference databases with values related to the data structures described in the discussions of FIGS. 4-5E. These other tables and fields may, for example, identify domains 507, resources 505, opportunities 511, costs 527 and cost types 529, or other data elements described in FIGS. 4-5E.

In step 305, the one or more processors begin evaluating the user's proposed solution by creating a new record in the Strategic Planning database 213 that, when fully populated, will identify characteristics of the proposed solution.

The information entered into this record in step 305 may be selected by methods, tools, or techniques known to those skilled in the art. The one or more processors may, for example, solicit the information from a user by a combination of a computerized or paper form, an interactive computerized question-and-answer session, manual or automated retrieval from an extrinsic information repository, inference from other identified information, or an other information-gathering mechanism.

In some embodiments, a record of Strategic Planning database 213 may comprise fields of information stored in a format:

business goals
business/industry drivers
realization feasibility
resource availability
current initiative
organizational process
domain knowledge
opportunity information
alignment compatibility

Each of these fields is discussed in greater detail above and in the descriptions of analogous data structures of FIGS. 5A-5E. In some embodiments, one or more records of the database 205 may comprise a variation of this format or may assume any of several formats.

For example, in the earlier stock-price example, a record of Strategic Planning database 213 might identify a business goal of increasing sales revenues by 10%, a business/industry driver of raising the user company's market capitalization by increasing its stock price, or a realization feasibility that identifies a likelihood that the objective is reasonable and practically obtainable.

In some embodiments, more than one record may be populated in step 305, when a user has proposed multiple candidate solutions or wishes to consider a validity of a proposed solution under multiple candidate scenarios.

In some embodiments, a record of Strategic Planning database 213 may not be fully populated in step 305. As will be described below, the processors may in step 309 solicit further information as a way to fill in the missing fields.

In step 307, the one or more processors identify one of the decision-making patterns characterized by a record of the Scenario Patterns Usage/Benefits database 205 as a “reference” pattern, implicit to the current scenario/solution combination, that may be used to conceptualize, relate, or organize elements of the proposed solution within the context of the scenario.

This identification may be performed as a function of criteria stored in the Scenario Patterns Usage/Benefits database 205, of fields of the Strategic Planning record created in step 305, of a characteristic of the user, the user's business, an extrinsic factor that may affect the user's business, or some other element associated with the proposed solution, the user, the scenario, or the pattern.

In the ongoing stock-price example, a user may have selected a proposed solution that comprises entering a foreign market. If undertaken, this solution would be implemented within a context of a scenario in which the user wishes to increase its stock price under financial conditions that are exerting downward pressure on stock prices of companies that do not have a global presence. Here, the user would in step 305 have created and partially populated a record in the Strategic Planning database that describes characteristics of the proposed solution. This partially populated record might, for example, identify a business goal of increasing stock price by 10%, a business/industry driver that identifies a positive effect of a higher stock price on the user's ability to raise new capital, a domain that relates the solution to the foreign consumer-electronics industry, and a current initiative that comprises steps necessary to begin selling product in an foreign market.

If, in this example, the one or more processors then identifies a corresponding pattern record of the Scenario Patterns Usage/Benefits database 205 as a candidate reference pattern, this candidate record might be associated with an organizational pattern implicit to the proposed solution within the context of the current scenario. The candidate record might, for example, identify eight elements or requirements that must exist in order for the pattern to accurately characterize the proposed solution. Such requirements might include: availability of organizational processes necessary to implement each step of the current initiative; a linkage between stock price and global market share; or a relationship between current market capitalization and an ability to raise capital.

The processors in step 307 thus search through the Scenario Patterns Usage/Benefits database 205 for a record that best matches the proposed solution (as characterized by the new Strategic Planning record created in step 305) contextualized within the current scenario. In some embodiments, the Scenario Patterns Usage/Benefits database 205 store a set of records for each possible scenario, where each record (of a set of records associated with a first scenario) identifies a pattern associated with one proposed solution. In other embodiments, records of the Scenario Patterns Usage/Benefits database 205 may be organized differently.

In step 309, the one or more processors request information missing from the Strategic Planning record created in step 305 as a function of the candidate decision-making pattern identified in step 307. In some embodiments, this step may comprise determining whether requirements identified by the pattern record, but not identified by a partially or fully populated Strategic Planning record, are met by the proposed solution.

This additional requested information may be identified by means that include, but are not limited to, combinations of: interactively or noninteractively asking a user a sequence of questions; searching for data stored in an information repository; deducing the missing information from contents of the set of reference databases; deducing the missing information from contents of the first record; requesting the missing information from a person or system possessing expert knowledge associated with the first proposed solution; or requesting information from some other reference or expert source.

In some embodiments, all or part of this additional information may be requested by the Ghost-Pattern QA Contextual Evaluator 203, which solicits information from extrinsic sources, such as a user or an external database, by asking a sequence of questions. order to: contextualize previously collected information that may be forwarded to other components; to populate instances of a Ghost-Pattern framework data model; or to help quantify subjected elements of the previously collected decision-making information.

This soliciting may be performed interactively or noninteractively by asking questions selected from the Question/Answer Database 201. In some embodiments, this database may store each question as a record of a Questions table and may further store each possible answer as a record in an Answers table. The QA Database 201 may also associate questions and answers in one-to-one, one-to-many, many-to-one, or many-to-many relationships, or may associate questions or answers with patterns, scenarios, goals, or other components of the ghost-pattern analyzer logic or data structures.

In some embodiments, a set of questions stored in the QA Database 201 may be ordered in a fixed sequence. In other embodiments, the QA Database 201 or the Ghost-Pattern QA Contextual Evaluator 203 may store or access logic that enables the Ghost-Pattern QA Contextual Evaluator 203 to interactively choose a next question to ask based on criteria that may comprise, but are not limited to, combinations of: a previous answer, a characteristic of the user, a characteristic of the current scenario, an element of the reference pattern, information stored in the new Strategic Planning record created in step 305, or other criteria related to the performance of the method of the embodiment.

In the above example, a candidate reference decision-making pattern might identify a requirement for an organizational process that facilitates high-volume manufacture of LED displays at a location near to an assembly plant in the foreign market. If the pattern record created in step 305 does not indicate whether such a process would be available, the processors in step 309 might attempt to determine whether such availability exists. In some embodiments, the processors might then store the result of this attempt in an other record or table, where it might be incorporated into a field of an alignment table 509 or other data structure that tracks which pattern elements or requirements are satisfied by the proposed solution.

Other embodiments may perform step 309 by incorporating other logical processes that relate requirements of a decision-making pattern, within the context of the current scenario, to the proposed solution. These processes may be implementation-dependent or may be specific to a particular user, business, or industry, but in all cases, they will provide steps by which the one or more processors identify information needed to determine whether requirements of the pattern record are satisfied by the proposed solution within the context of the current scenario.

At the conclusion of step 309, the one or more processors will have gathered and used additional or extrinsic information to further populate the Strategic Planning record created in step 305. In some embodiments, this information-gathering procedure may have also resulted in population of one or more fields of other tables of the ghost-pattern analyzer data structure (shown in FIGS. 4-5E).

In step 311, the one or more processors determines whether the proposed solution, as represented by the Strategic Planning record created in step 305 and updated in step 309, is aligned with the user's goals within the context of the current scenario. This determining may be performed automatically by examining a state of one or more records of alignment table 509, which may, as explained in the description of FIGS. 5A-5B, automatically link components of the Strategic Planning record, such as domain knowledge or current initiative, to elements of the reference decision-making pattern record selected in step 307.

In other embodiments, alignment may be all or in part identified by other means, such as comparing values of analogous fields in the Strategic Planning record and the decision-making pattern record, or by detecting whether requirements specified by the decision-making pattern record are feasible within the context of the current scenario. In some cases, the processors may perform a “gap analysis” that determines whether a value or element required by a pattern is either not present in the ghost-pattern analyzer data structure or has a value that is differs from the required value by a wide gap.

In some embodiments, some or all of these determinations may be implemented as code in a computer program that examines contents of the database records created or loaded with data in steps 301, 303, 305, and 309.

In one example, a user may define an objective of improving employee satisfaction among employees of an Engineering Department. This objective may give rise to a candidate policy of enrolling each Engineering employee in a three-day conference in Honolulu. The user may, however, instead propose a revised solution in which each employee attending such a conference is required to personally cover the cost of airfare to and from the conference.

In this example, the one or more processors may select a reference pattern in step 307 that identifies an objective of improving employee satisfaction by providing each employee a seat at a three-day conference. Because this requirement is not fully met by the proposed solution, the one or more processors might report a misalignment between the proposed solution and the desired objective—thus identifying the reference pattern as a ghost pattern that does not accurately represent a characteristic of, or a likely result of, the proposed solution.

In step 313, the one or more processors attempt to reconcile a misalignment that may have been identified in step 311. Here, the system might advise the user of the misalignment and ask the user to revise the proposed solution. If the user is not able to do so, the one or more processors may request additional information, select a different decision-making pattern that is more closely aligned to the proposed solution, or inform the user that no solution has been identified that is likely to achieve the user's objective.

If no misalignment was identified in step 311, the one or more processors may not need to perform step 313, instead continuing to step 315 using the initial reference pattern identified in step 307. In some embodiments, steps 309-313 may be repeated multiple times until a reference pattern, proposed solution, or other parameters are identified such that the proposed solution aligns with the user's objectives, goals, strategy, initiative, scenario, or other parameter.

In step 315, the one or more processors score and rank the proposed solution as a function of the alignment findings of step 311, of the pattern revision or reselection of step 315, or of other criteria related to how closely elements of the Strategic Planning record created in step 305 match elements of the reference pattern record identified in step 307 or 313.

This scoring and ranking may be a function of any criteria identified in step 311. It may also be a function of costs 527 and benefits 525 associated with a reference pattern 515, as illustrated in FIG. 5C.

In some embodiments, the one or more processors may perform steps 305-313 multiple times, once for each of a set of proposed solutions. In such cases, the processors may in step 315, score and rank each proposed solution and communicate aggregated results to a user in step 317. In similar embodiments, the one or more processors may perform steps 305-313 only once, but may retain scorings and rankings derived during previous iterations of the method of FIG. 3. In such cases, the one or more processors may in step 315 report aggregated past and current results to a user in step 317.

In step 317, the scoring and ranking of step 315 is communicated to a user in the form of a scorecard, dashboard, user interface, table, spreadsheet, chart, or other reporting mechanism known to those skilled in the art. In an example wherein three proposed solutions are being evaluated, the one or more processors in step 315 might rank three proposed solutions in order of likelihood that each one will produce a desired objective. In one example, the three solutions might be reported as:

| Proposed Solution | Objective | Likelihood of Success |
|---|---|---|
| Stock buyback initiative | Increase stock price | 62% |
| Expand into foreign market | Increase stock price | 47% |
| Merger with competitor | Increase stock price | 37% |

Other information may be reported, such as an identification of points of misalignment, a recommended course of action, recommended revisions to a proposed solution, or a suggestion to the user to revise a characteristic of an objective, goal, strategy, initiative, scenario, proposed solution, or other element comprised by the decision-making procedures of FIG. 3. In some cases, patterns may be scored, ranked, assigned a likelihood of success, or reported in addition to or instead of the proposed solutions associated with the patterns.

At the conclusion of the method of FIG. 3, the one or more processors will have identified one or more solutions likely to attain the user's objectives within the context of the current scenario. The processors will have done this by discarding solutions that may be justified solely by illusory ghost patterns, instead recommend solutions that are more likely to attain the objectives based on patterns shown to more accurately represent the user's real-world situation.

FIG. 4 illustrates a high-level organization of an embodiment of a ghost-pattern data model 400, in accordance with embodiments of the present invention. FIG. 4 comprises items 401-13, all of which is shown in greater detail in FIGS. 5A-5E.

As described above, the embodiment of the ghost-pattern data model shown in FIG. 4 is a minimum implementation of a ghost-pattern data model comprised by embodiments of the present invention. The embodiment of the data model shown in FIG. 4 is extensible, meaning that additional data elements and logical relations may be added to it, as required by a specific embodiment or implementation. Such an extended version of the data model may, for example, include additional tables, columns, links, or other data structures, data elements, or logical relations that represent a characteristic related to a decision-making pattern, objective, goal, strategy, initiative, scenario, or other entity described in this document, wherein the represented characteristic may facilitate performance of a step of the method of FIG. 3.

FIG. 4 describes an embodiment of a ghost-pattern data model implemented as a schema of a relational database and FIGS. 5A-5E describe data structures or sub-schemas comprised by the data model as tables, records, and fields of the schema. But embodiments of the ghost-pattern data model may be implemented in any form and by any means known to those skilled in the art. Possible implementation options comprise, but are not limited to, implementation as a schema or sub-schema of a relational database, as a set of flat files, as one or more Excel worksheets, as a comma-delimited table, or as unstructured text.

Each instance of a ghost-pattern data model represents one proposed or historic decision-making pattern. A first instance of the ghost-pattern data model may, for example, comprise a data structure that stores information characterizing a domain, requirements, goals, costs, benefits, resources, and other entities associated with a particular decision-making pattern. Such an instance of the data model may thus comprise a quantified representation of a decision-making pattern, such as a pattern intrinsic to a user's proposed strategy or a pattern associated with a past strategy that has produced known results.

FIG. 4 thus comprises an overview of an entire ghost-pattern data model or data structure that is, for clarity, described as an embodiment implemented as a schema of a relational database.

Job Resources module 401 comprises a set of data structures that identify and characterize jobs and resources associated with the jobs. Each job may be an assigned task associated with or necessitated by a decision pattern represented by an instance of the data model. If, for example, a current instance of the data model represents a decision-making pattern associated with a proposed marketing plan, these data structures may identify each task comprised by the marketing plan and may associate each task with a set of resources required by the task. Components of item 401 are shown in greater detail in FIG. 5A.

Decision-Making Pattern module 403 comprises a set of data structures that identify a current decision-making pattern represented by the current instance of the data model and characterize a feasibility of the pattern. In the above example, these structures might identify the proposed marketing plan and represent whether the plan has been determined to be feasible. Components of item 403 are shown in greater detail in FIG. 5B.

Alignment module 405 comprises a set of data structures that identify and characterize how likely the current decision-making pattern is to enable a user to achieve a goal. This likelihood is determined by identifying how well the current pattern aligns with an opportunity to achieve that goal, when evaluated within a context of a specified domain. Components of item 405 are shown in greater detail in FIG. 5A.

Current Initiative module 407 comprises a set of data structures that identify processes that are associated with a current initiative. Components of item 407 are shown in greater detail in FIG. 5B.

Costs & Benefits module 409 comprises a set of data structures that identify costs and benefits associated with a decision-making pattern within a context of the current initiative and compile these costs and benefits into a “scorecard” report. Components of item 409 are shown in greater detail in FIG. 5C.

Goals & Objectives module 411 comprises a set of data structures that identify strategic objectives of a decision-making pattern and the business drivers and measurable business goals associated with those objectives. Components of item 409 are shown in greater detail in FIG. 5D.

Context & Pattern Relevance module 413 comprises a set of data structures that identify scenarios (projected sequences of events) and associates each scenario with a pattern. These data structures also provide context for each scenario and identify relevant questions and answers that may be used to solicit information that provides this context. Components of item 413 are shown in greater detail in FIG. 5E.

The data elements or tables comprised by a minimum embodiment of the ghost-pattern analyzer's main data structure, as summarized in FIGS. 4-5E. Many other tables, fields, and data sub-structures may be added, as required by implementation-specific requirements of a particular embodiment.

FIGS. 5A-5E illustrate the modules of FIG. 4 in greater detail. These five figures use crow's foot notation to indicate one-to-many relationships between pairs of data structures. In FIG. 5A, for example, this notation indicates that one record of job table 501 may be associated with one or more records of job-resources table 503.

FIG. 5A illustrates details of items of FIG. 4 that comprise the Job Resources module 401 and the Alignment module 405 (which interfaces with Decision-Making Pattern module 403, Current Initiative module 407, and Goals & Objectives module 411).

As described above, Job Resources module 401 comprises a set of data structures that identify and characterize jobs and resources associated with each job, and Alignment module 405 comprises a set of data structures that identify and characterize how likely the current decision-making pattern is to enable a user to achieve a goal. 5A.

Job Resources module 401 comprises a job table 501 and a resources table 505 that are related by a job_resources table 503.

Job table 501 stores records that each identify one task associated with a current initiative represented by a current instance of the ghost-pattern data model 400. In one example, if an initiative comprises a manufacturing-process plan, job table 501 may comprise records that each correspond to one task of that manufacturing-process plan. These corresponding records may, for example, respectively describe a workflow-planning task, a retooling task, an inventory-management task, or a staffing task. Each job record is identified by a job identifier.

Resources table 505 stores records that each identify a resource that might be required by a proposed solution or course of action. Each record of table 505 may also contain a flag that identifies whether a resource identified by that record is available, possibly as a function of contextual constraints identified by an associated scenario. Each resource record is identified by a resource identifier.

Job_resources table 503 associates tasks identified by the job table 501 with resources identified by resources table 505. Each record of job-resources table 503 identifies one such association and may be retrieved by either a resource identifier or by a job identifier. Each record of job-resources table 503 may further describe a combination of the job and the resource identified by that record. Each record of job table 501 may be associated with many records of job-resources table 503 and each record of resources table 505 may be associated with many records of job-resources table 503. Thus job-resources table 503 may associate one task with many resources and may associate one resource with many tasks.

Alignment module 405 comprises a domain_knowledge table 507 and an opportunity table 511 that are related by an alignment table 509.

Domain_knowledge table 507 comprises records that each describe a domain associated with a scenario or proposed solution. In one example, a record of domain_knowledge table 507 might identify the consumer-electronics industry, the Asian cell-phone market, or domestic sales of blood-pressure medications.

Opportunity table 511 comprises records that each identify or describe an opportunity or a chance for a user to obtain a benefit. Each record of this table may further identify a beneficiary of such an opportunity. An opportunity record might, for example, specify an opportunity for a cell-phone manufacturer to cut production costs or might describe an opportunity for a customer-service organization to reduce queue times.

Alignment table 509 stores records that each relate a record of the domain_knowledge table 507 and a record of the opportunity table 511 with a record of a current_initiative table 517 and a record of the job_resources table 503. Such an alignment record may further comprise an alignment flag that indicates whether entities identified by each of these record are aligned with, or in conformance with, the current initiative. If sufficient alignment exists for this combination, an alignment flag is set in the alignment table 509. An exact definition of “alignment” may be at least partly implementation-dependent, but in general, a pattern is considered to be more closely aligned with a proposed user solution or course of action (as defined by a planning record of the Strategic Planning database 213) if the planning record comprises identifications of a greater number of elements identified by the pattern, or if a greater number of values of those elements are separated by a smaller gap from reference or threshold values identified by the patterns.

Many records of alignment table 509 may be associated with each record of domain_knowledge table 507, with each record of job-resources table 503, with each record of current_initiative table 517, with each record of opportunity table 511, and with each record of job-resources table 503. An alignment record may thus identify which combinations of these entities are in alignment with a particular initiative.

In one example, a record of alignment alignment table 509 might indicate that the current initiative, as identified by a record of current_initiative table 517 is aligned with a domain identified by a record of domain_knowledge table 507 record, with an opportunity identified by a record of an opportunity table 51, and with a task and associated resource identified by a record of job_resources table 503.

FIG. 5B illustrates details of items of FIG. 4 that comprise the Decision-Making Pattern module 403 and the Current Initiative module 407, which both interface with Alignment module 405.

As described above, Decision-Making Pattern module 403 comprises a set of data structures that identify the proposed current_initiative under analysis, which is represented by the current instance of the data model, and that characterize a feasibility of the initiative. As described above, Current Initiative module 407 comprises a set of data structures that identify the current initiative and further identify business processes associated with the current initiative.

Decision-Making Pattern module 403 comprises a decision_making_pattern table 515 and a realization_feasibility table 513.

Decision_making_pattern table 515 stores records that each identifies characteristics or elements of one decision-making pattern associated with the current initiative represented by current instance of the ghost-pattern data model. Records of this table also identify a record of alignment table 509. In one example, a record of the decision_making_pattern table 515 might identify a pattern that associates a global marketing domain with a rising stock price. Such a record might identify elements that include a flag indicating whether this pattern is in alignment with a user's proposed solution or course of action, or might include a link to a record of the realization_feasibility table 513.

The realization_feasibility table 513 stores records that each indicate that a feasibility or infeasibility of a decision-making pattern. In embodiments of the present invention, each record of the decision_making_pattern table 515 is associated with one record of the realization_feasibility table 513 that indicates whether that decision_making_pattern record is feasible or infeasible. A pattern may be designated as feasible or infeasible as a function of whether the pattern is identified as being in alignment with objectives and proposed solutions by a corresponding record of alignment table 509.

Current Initiative module 407 comprises a current_initiative table 517 and an organizational_process table 521 that are related by an initiative_processes table 519.

The current_initiative table 517 comprises records that each identify an initiative comprised by the proposed solution, wherein the initiative is intended by the user to achieve an objective or goal.

The organizational_process table 521 stores records that each identify one business process that may be associated with a user. Such a record might, for example, identify a manufacturing, distribution, accounting, or information-technology process.

Each record of the initiative_processes table 519 associates an organizational process identified by a record of the organizational_process table 521, with a current initiative identified by a record of the current_initiative table 517. One record of the current_initiative table 517 may be associated with many records of the initiative_processes table 519, each of which associates one organizational process with the current initiative identified by the record of the current_initiative table 517. One record of the organizational_process table 521 may be associated with many records of the initiative_processes table 519, each of which associates an initiative with one of organizational process identified by the record of the organizational_process table 521.

In one example, two records of the organizational_process table 521 might respectively identify a keyboard-manufacturing business process and a European-distribution business process. If these processes are associated with an initiative aimed at expanding sales into Western Europe, as identified by a first record of the current_initiative table 517, the two records of the organizational_process table 521 would each be associated with the first record of the current_initiative table 517 by a respective record of the initiative_processes table 519.

FIG. 5C illustrates details of items of FIG. 4 that comprise the Costs & Benefits module 409, which interfaces with Decision-Making Pattern module 403 and Context & Pattern Relevance module 413.

As described above, Costs & Benefits module 409 comprises a set of data structures that identify costs and benefits associated with a decision-making pattern within a context of the current initiative and compile these costs and benefits into a “scorecard” report.

Costs & Benefits module 409 comprises a benefits table 525, a cost table 527, a cost_type_ID table 529, and a cost_benefit_scorecard table 523 that associates records of the benefits table 525 with records of the cost table 527.

Benefits table 525, stores records that each identifies one possible benefit of a particular pattern usage and further identify a record of pattern_usage table 539. Such a benefit record might, for example, identify an increased stock price, lower manufacturing costs, or reduced sick time.

Each record of cost_type_ID table 529 identifies one type of cost that may be associated with a decision-making pattern. In some embodiments, such a cost type record might identify labor costs or inventory costs. Each cost_type_ID record may be associated with many records of cost table 527 because many costs may be associated with a same cost type.

Each record of cost table 527 describes one cost that might be associated with a decision-making pattern. Each cost record further associates the one cost with a cost_type_ID identified by a record of cost_type_ID table 529.

Each record of cost_benefit_scorecard table 523 identifies a cost-benefit score as a function of a cost associated with a decision-making pattern and of a benefit associated with the decision-making pattern. Each record of the cost_benefit_scorecard table 523 is thus associated with a record of benefits table 525, with a record of cost table 527, and with a record of decision_making_pattern table 515. Many records of the cost_benefit_scorecard table 523 may be associated with each record of cost table 527 or with each record of benefits table 525.

FIG. 5D illustrates details of items of FIG. 4 that comprise the Goals & Objectives module 411, which interfaces with Alignment module 405.

As described above, Goals & Objectives module 411 comprises a set of data structures that identify strategic objectives of an initiative and the business drivers and measurable business goals associated with those objectives.

Goals & Objectives module 411 comprises a business_goals table 535, a strategic_objective table 533, and an objective_goals table 531 that associates records of the business_goals table 535 with records of the strategic_objective table 533. In one example, an objective of raising a company's stock price might be represented by one record of the strategic_objective table 533 and three records of the business_goals table 535 might respectively represent goals of entering a foreign market, increasing productivity, and reducing interest-bearing debt. Because all three of these goals may be engaged as steps toward an objective of raising the stock price, three records of objective_goals table 531 would each associate one of the three business_goal records with the strategic_objective record.

Goals & Objectives module 411 also comprises a business_driver table 537 that identifies factors that may motivate a user's interest in attaining an objective. Here, a business_driver record that identifies a relationship between higher market capitalization and a greater ability to attract investors might be represented as motivating an objective of increasing stock price by a link between corresponding records of the strategic_objective table 533 and the business_driver table 537.

FIG. 5E illustrates details of items of FIG. 4 that show the details of the Context & Pattern Relevance module 413 (which interfaces with Cost & Benefits module 409), comprising a set of data structures that identify scenarios (projected sequences of events) and associates each scenario with a pattern, with contextual information, and with questions and answers that may be used to solicit information that provides this context.

Pattern_usage table 539 is a data structure that stores pattern-usage records that each identify a repeatable pattern of performing a process to achieve a goal. In one example, a record of pattern_usage table 539 pattern usage may identify a first pattern usage of a decision-making pattern that comprises applying that decision-making pattern in such a way as to increase revenues by expanding into the Japanese consumer-electronics market. In another example, another pattern_usage record might identify a second pattern usage that comprises applying the decision-making pattern in such a way as to reduce manufacturing costs by opening a factory in China.

Scenario table 547 is a data structure that identifies a scenario. In one example, an instance of scenario table 547 might identify a scenario in which a drop in housing prices has caused a contraction of a market for building supplies.

Scenario_pattern_usage table 541 is a data structure that links a particular scenario, identified by an instance or record of scenario table 547, to a pattern usage identified by an instance or record of pattern_usage table 539. In the preceding example, a record of Scenario_pattern_usage table 541 might associate a record of scenario table 547, which identifies a scenario that comprises falling housing prices, with a record of pattern_usage table 539 that identifies a type of pattern_usage that applies decision-making patterns to initiatives intended to reduce high unemployment rates.

Context table 545 stores information that provides contextual information associated with scenarios represented by records of scenario table 547. In the previous example, the record of scenario table 547 that identifies a market contraction caused by a drop in housing prices might derive context from one or more records of context table 545 that each provide “who/what/where/why/when” context for that scenario. Such context might, for example, identify that such a scenario applies to commercial housing markets (“who/what”) on the West Coast of the United States (“where”), is caused by rising interest rates (“why”), and occurs within 60 days of an unfavorable change in interest rates (“when”).

QA table 543 stores questions and answers to questions that may be used by the Ghost-Pattern QA Contextual Evaluator 203 to identify contextual information stored in context table 545, as described in step 309 of FIG. 3. In some embodiments, this table, or an other subset of the tables comprised by the Context & Pattern Relevance module 413, may be stored in the QA Database 201. In some embodiments, a copy of, or a link to, the contents of this table, or of an other subset of the tables comprised by the Context & Pattern Relevance module 413, may be stored in the QA Database 201.

The QA table may store a set of questions from which the Ghost-Pattern QA Contextual Evaluator 203 may select questions to present to a user in step 305 or 309 of FIG. 3 in order to identify or refine contextual information about a scenario, proposed course of action, or other entity comprised by an embodiment of the present invention.

In some embodiments, each record of the QA table 543 may comprise a text of a question and an identifier of a question that may be used to associate the question to an answer or to other contextual information associated with the question, where this other contextual information may be used by the Ghost-Pattern QA Contextual Evaluator in step 305 or 309 of FIG. 3.

In some embodiments, a question stored in the QA table 543 may take the form of a journalist's context-gathering “Who/what/when/where/why/how?” question, such as: “What metrics will be measured?”, “Where will metrics be collected?”, “When will the metrics be collected?”, “How will each metric be collected?”, “Who is your target audience?”, “How much will a proposed product cost?”, or “When would the product be launched?”

A record of the QA table 543 may further comprise other fields that store identifiers that allow it to cross-reference a question or an answer to other parameters stored in an other table or record, such as to a record of context table 545.

What is claimed is:

1. A method for identifying and eliminating a false pattern among elements of a proposed course of action, the method comprising:
a processor of a computer system initializing a reference database with records that are each associated with a pattern of decision-making factors, wherein a first pattern of the plurality of patterns is associated with a first proposed course of action undertaken within a first scenario in order to attain a first objective, and wherein a second pattern of the plurality of patterns is associated with a second proposed course of action undertaken within the first scenario in order to attain the first objective;
the processor storing in a first record of a planning database information that describes the first proposed course of action;
the processor selecting the first pattern as a function of information stored in the first record;
the processor identifying information missing from the first record as a function of the first pattern;
the processor attempting to retrieve the missing information;
the processor updating the first record as a function of the retrieved information;
the processor determining that the updated first record is not aligned with the first pattern;
the processor choosing the second pattern in response to the determining;
the processor concluding that the updated first record is aligned with the second pattern; and
the processor confirming that the first objective is aligned with the second proposed course of action as a function of the determining that the updated first record is aligned with the second pattern.

2. The method of claim 1, wherein the attempting to retrieve the missing information comprises steps selected from a group comprising: asking a user a sequence of questions; searching for data stored in an information repository; deducing the missing information as a function of contents of the reference database; deducing the missing information from contents of the first record; and requesting the missing information from a person or system possessing expert knowledge associated with the first proposed solution.

3. The method of claim 2, wherein a next question of the sequence of questions is selected as a function of factors selected from a group comprising: an answer to an earlier question of the sequence of questions; a characteristic of the user; a characteristic of the first pattern; information stored in the first record; and a characteristic of the first scenario.

4. The method of claim 1, wherein the reference database further comprises a set of question records that each identify a question of the sequence of questions, a set of answer records that each identify an answer to a question identified by a question record of the set of question records, and logic that associates each answer record of the set of answer records with at least one question record of the set of question records.

5. The method of claim 1, wherein the first scenario identifies a set of circumstances, constraints, objectives, plans, events, environmental factors, other extrinsic conditions, or other contextual information that each characterize a real-world situation.

6. The method of claim 1, wherein the first record is aligned with the first pattern only if information comprised by the first record satisfies all requirements identified by the first pattern as being necessary to achieve the first objective within the first scenario.

7. The method of claim 1, wherein a likelihood that the first proposed course of action will achieve the first objective within the first scenario is a function of a degree of alignment between the first record and the first pattern, and wherein a likelihood that the second proposed course of action will achieve the first objective within the first scenario is a function of a degree of alignment between the first record and the second pattern.

8. The method of claim 1, further comprising providing at least one support service for at least one of creating, integrating, hosting, maintaining, and deploying computer-readable program code in the computer system, wherein the computer-readable program code in combination with the computer system is configured to implement the initializing, storing, selecting, identifying, attempting to retrieve, updating, determining, choosing, concluding, and confirming.

9. A computer program product, comprising a computer-readable hardware storage device having a computer-readable program code stored therein, said program code configured to be executed by a processor of a computer system to implement a method for identifying and eliminating a false pattern among elements of a proposed course of action, the method comprising:
the processor initializing a reference database with records that are each associated with a pattern of decision-making factors, wherein a first pattern of the plurality of patterns is associated with a first proposed course of action undertaken within a first scenario in order to attain a first objective, and wherein a second pattern of the plurality of patterns is associated with a second proposed course of action undertaken within the first scenario in order to attain the first objective;
the processor storing in a first record of a planning database information that describes the first proposed course of action;
the processor selecting the first pattern as a function of information stored in the first record;
the processor identifying information missing from the first record as a function of the first pattern;
the processor attempting to retrieve the missing information;
the processor updating the first record as a function of the retrieved information;
the processor determining that the updated first record is not aligned with the first pattern;
the processor choosing the second pattern in response to the determining;
the processor concluding that the updated first record is aligned with the second pattern; and
the processor confirming that the first objective is aligned with the second proposed course of action as a function of the determining that the updated first record is aligned with the second pattern.

10. The computer program product of claim 9, wherein the attempting to retrieve the missing information comprises steps selected from a group comprising: asking a user a sequence of questions; searching for data stored in an information repository; deducing the missing information as a function of contents of the reference database; deducing the missing information from contents of the first record; and requesting the missing information from a person or system possessing expert knowledge associated with the first proposed solution.

11. The computer program product of claim 10, wherein a next question of the sequence of questions is selected as a function of factors selected from a group comprising: an answer to an earlier question of the sequence of questions; a characteristic of the user; a characteristic of the first pattern; information stored in the first record; and a characteristic of the first scenario.

12. The computer program product of claim 9, wherein the reference database further comprises a set of question records that each identify a question of the sequence of questions, a set of answer records that each identify an answer to a question identified by a question record of the set of question records, and logic that associates each answer record of the set of answer records with at least one question record of the set of question records.

13. The computer program product of claim 9, wherein the first scenario identifies a set of circumstances, constraints, objectives, plans, events, environmental factors, other extrinsic conditions, or other contextual information that each characterize a real-world situation.

14. The computer program product of claim 9, wherein the first record is aligned with the first pattern only if information comprised by the first record satisfies all requirements identified by the first pattern as being necessary to achieve the first objective within the first scenario.

15. The computer program product of claim 9, wherein a likelihood that the first proposed course of action will achieve the first objective within the first scenario is a function of a degree of alignment between the first record and the first pattern, and wherein a likelihood that the second proposed course of action will achieve the first objective within the first scenario is a function of a degree of alignment between the first record and the second pattern.

16. A computer system comprising a processor, a memory coupled to said processor, and a computer-readable hardware storage device coupled to said processor, said storage device containing program code configured to be run by said processor via the memory to implement a method for identifying and eliminating a false pattern among elements of a proposed course of action, the method comprising:
the processor initializing a reference database with records that are each associated with a pattern of decision-making factors, wherein a first pattern of the plurality of patterns is associated with a first proposed course of action undertaken within a first scenario in order to attain a first objective, and wherein a second pattern of the plurality of patterns is associated with a second proposed course of action undertaken within the first scenario in order to attain the first objective;
the processor storing in a first record of a planning database information that describes the first proposed course of action;
the processor selecting the first pattern as a function of information stored in the first record;
the processor identifying information missing from the first record as a function of the first pattern;
the processor attempting to retrieve the missing information;
the processor updating the first record as a function of the retrieved information;
the processor determining that the updated first record is not aligned with the first pattern;
the processor choosing the second pattern in response to the determining;
the processor concluding that the updated first record is aligned with the second pattern; and
the processor confirming that the first objective is aligned with the second proposed course of action as a function of the determining that the updated first record is aligned with the second pattern.

17. The computer system of claim 16, wherein the attempting to retrieve the missing information comprises steps selected from a group comprising: asking a user a sequence of questions; searching for data stored in an information repository; deducing the missing information as a function of contents of the reference database; deducing the missing information from contents of the first record; and requesting the missing information from a person or system possessing expert knowledge associated with the first proposed solution.

18. The computer system of claim 16, wherein the reference database further comprises a set of question records that each identify a question of the sequence of questions, a set of answer records that each identify an answer to a question identified by a question record of the set of question records, and logic that associates each answer record of the set of answer records with at least one question record of the set of question records.

19. The computer system of claim 16, wherein the first scenario identifies a set of circumstances, constraints, objectives, plans, events, environmental factors, other extrinsic conditions, or other contextual information that each characterize a real-world situation.

20. The computer system of claim 16, wherein the first record is aligned with the first pattern only if information comprised by the first record satisfies all requirements identified by the first pattern as being necessary to achieve the first objective within the first scenario.
